(19) United States
(12) Patent Application Publication
(10) Pub. No.: US 2019/0154712 A1
(43) Pub. Date: May 23, 2019

(54) SYSTEM AND METHOD OF AUTOMATING A TITRATION

(71) Applicant: Shawn Matthew MARTIN, Fort Mill, SC (US)

(72) Inventor: Shawn Matthew MARTIN, Fort Mill, SC (US)

(21) Appl. No.: 16/308,554

(22) PCT Filed: May 25, 2017
(86) PCT No.: PCT/US2017/034569

§ 371 Date: Dec. 10, 2018

Related U.S. Application Data
(63) Continuation-in-part of application No. 15/179,019, filed on Jun. 10, 2016.

(51) Int. Cl. G01N 35/00; G01N 1/14

(52) U.S. Cl. CPC G01N 35/0099; G01N 31/16; G01N 1/14; G01N 35/00871

(57) ABSTRACT

A system for titrating a solution is provided. The system includes a robotic arm, a titrator, a solution pump, and infusion pump, a scale, and an autonomous cup drying carriage. The system further includes a computer having a memory and a programmable logic controller. The computer may be a programmable logic controller. The programmable logic controller of the computer activates the solution pump to pump a solution into a drip chamber, directs the robotic arm to place a cup on the scale, activates the infusion pump to drip the solution from the drip chamber into the cup until a threshold weight has been reached, and directs the robotic arm to transport the cup to the titrator.

### CROSS-REFERENCE TO RELATED APPLICATION(S)

The present application claims priority to U.S. Non-Provisional patent application Ser. No. 15/179,019 filed on Jun. 10, 2016, entitled “SYSTEM AND METHOD FOR AUTOMATING A TITRATION” the entire disclosure of which is incorporated by reference herein.

### BACKGROUND OF THE INVENTION

### 1. Field of the Invention

The present disclosure relates to titration and, more particularly, to a system and method of automating a titrator.

Titration is a technique where a solution of known concentration is used to determine the concentration of an unknown solution. Typically, the titrant (the known solution) is added from a burette to a known quantity of the analyte (the unknown solution) until the reaction is complete. To perform a titration, a lab technician is needed to gather and weigh solutions, wash cups, take results and make line adjustments to liquids that require titration or other lab testing. The current system includes unnecessary delays and a misuse of man hours.

As can be seen, there is a need for an improved automated system for titrating a solution.

### SUMMARY OF THE INVENTION

In one aspect of the present invention, a system for titrating a solution, wherein the system comprises: a robotic arm; a titrator; a solution pump; an infusion pump; a scale; and

a computer comprising a memory and a programmable logic controller, wherein the programmable logic controller activates the solution pump to pump a solution into a drip chamber; directs the robotic arm to place a cup on the scale; activates the infusion pump to drip the solution from the drip chamber into the cup until a threshold weight has been reached; and directs the robotic arm to transport the cup to the titrator, wherein the solution is titrated.

In another aspect of the present invention, a method of titrating a solution comprises the steps of: pumping a solution into a drip chamber via a solution pump; dripping the solution from the drip chamber into a cup via an infusion pump, wherein the cup is on a scale; transporting the cup to a titrator once a threshold weight has been detected, wherein the cup is transported from the scale to the titrator by a robotic arm controlled by a computer, and the solution is titrated by the titrator.

These and other features, aspects and advantages of the present invention will become better understood with reference to the following drawings, description and claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic view of the titration setup, according to an embodiment of the present invention;

FIG. 2A is a perspective view of the robotic arm, sample cup, and titrator, according to an embodiment of the present invention;

FIG. 2B is a perspective view of the robotic arm and sample cup, according to an embodiment of the present invention;

FIG. 2C is a perspective view of the robotic arm draining the sample cup, according to an embodiment of the present invention;

FIG. 2D is a schematic view of the robotic arm and sample cup, according to an embodiment of the present invention;

FIG. 2E is a schematic view of the robotic arm and sample cup, according to an embodiment of the present invention;

FIG. 2F is a perspective view of the robotic arm, sample cup, and titrator, according to an embodiment of the present invention;

FIG. 3A is a front elevation view of the drying carriage, according to an embodiment of the present invention; and

FIG. 3B is a front elevation view of the drying carriage, according to an embodiment of the present invention; and

FIG. 3C is a perspective view of the drying carriage and drain, according to an embodiment of the present invention; and

FIG. 3D is a perspective view of the drying carriage and drain, according to an embodiment of the present invention; and

FIG. 3E is a cut-away perspective view of the interior mechanics of the drying carriage, according to an embodiment of the present invention; and

FIG. 4 is a flowchart illustrating a method, according to an embodiment of the present invention;

FIG. 5 is a flowchart illustrating a method, according to an embodiment of the present invention; and

FIG. 6 is a schematic view, according to an embodiment of the present invention.

### DETAILED DESCRIPTION OF PREFERRED EMBODIMENTS

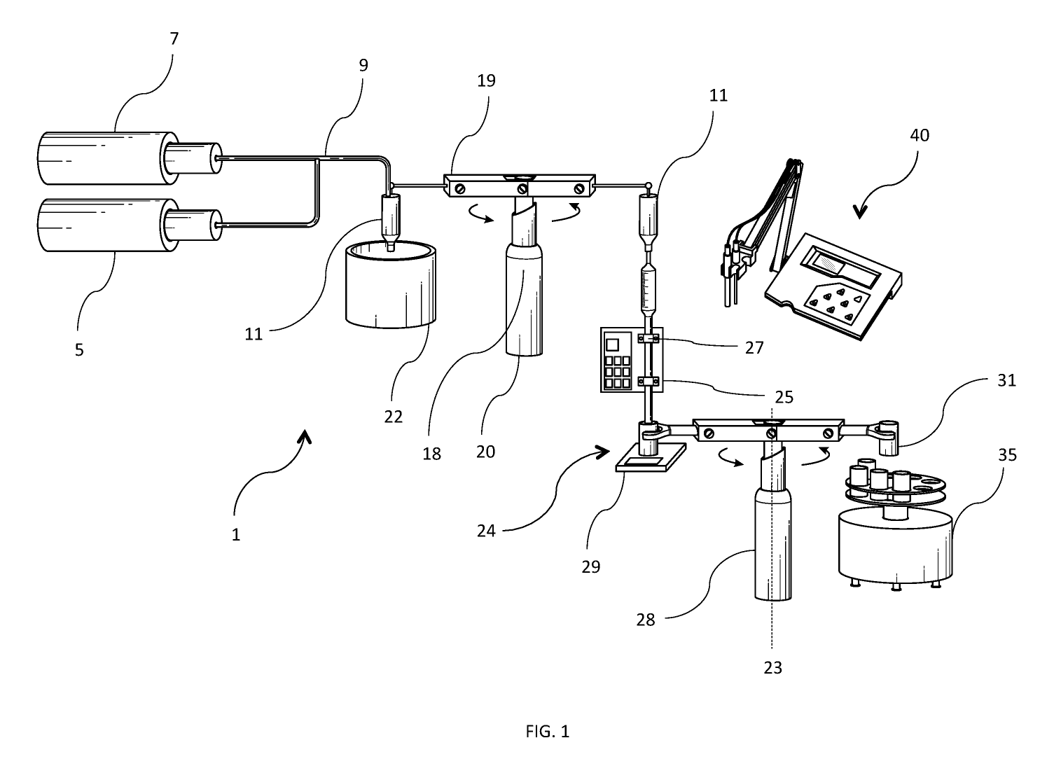

Preferred embodiments of the present invention and their advantages may be understood by referring to FIGS. 1-6, wherein like reference numerals refer to like elements.

In reference to FIG. 1, the automatic titration device 1 is illustrated in an embodiment of the present invention. A deionized water (DI) water pumps 5 and one or more solution pumps 7 are in fluid communication with a drip chamber 11. In a preferred embodiment, a plurality of supply lines 9 fluidly connect each pump with the drip chamber 11. A drain 22 is positioned under the drip chamber 11 allowing fluids to be discarded as required. A first robotic arm 20 is positioned to communicate with each of the supply lines 9, the drip chamber 11, and at least one infusion pump 25. The infusion pump 25, a flow preventer 27, and a scale 29 comprise the collection assembly 24. The robotic arm 20 engages and rotates the drip chamber 11 about a central axis 23 of rotation. Fluids are drained from the drip chamber 11 by the flow preventer 27 positioned below and in fluid communication with the infusion pump 25. A scale 29 is positioned under and in communication with a sample cup 31, wherein fluids are collected. A second robotic arm 28 is positioned between the scale 29 and a titrator 35.

In an embodiment, each robotic arm 20, 23 is comprised of a rotating body portion 18 and one or more members 19, extending substantially perpendicular to the body 18. Each member 19 is adapted to secure a vessel such as the sample cup 31 during periods of filling, draining, cleaning, analysis, or other processes known in the scientific arts. A programmable logic controller is in communication with each robotic arm 20, 23 to control movement and timing thereof.

In an embodiment, the device 1 is in fluid, mechanical, or otherwise in communication with a plurality of auxiliary analytics devices 40. The auxiliary analytics device 40 may include, but is not limited to, viscometers, pH meters, additional titrators, colorimeters, spectrometer, agitator, centrifuge, cleaning apparatuses, drains, and likewise equipment. The analytics device 40 may be positioned anywhere within a communicable distance from at least one of the robotic arms 20, 23.

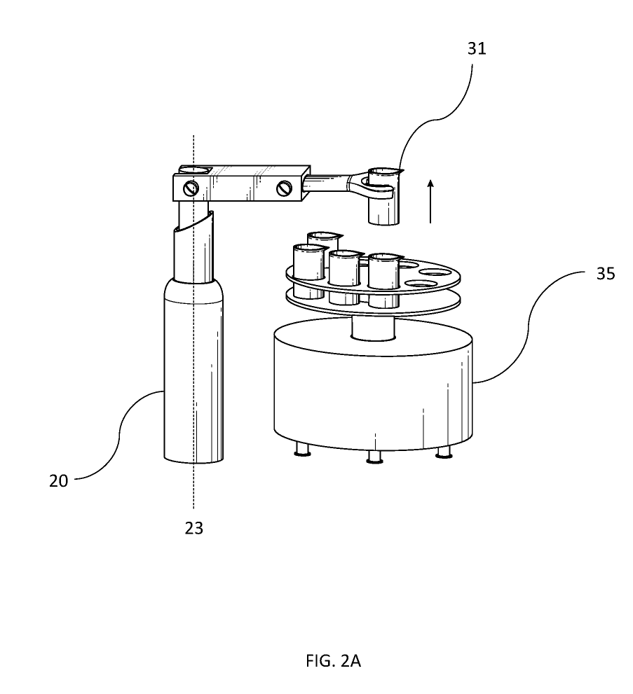

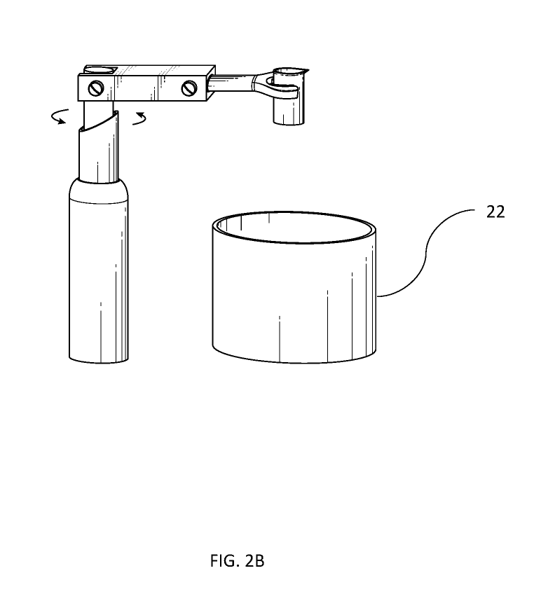

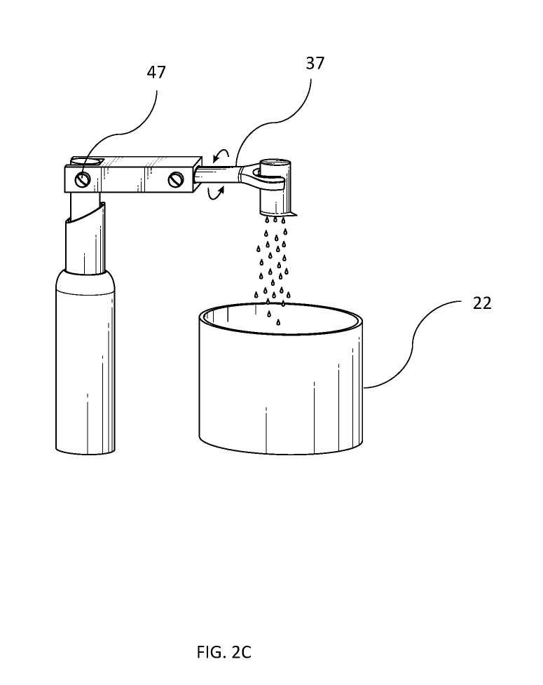

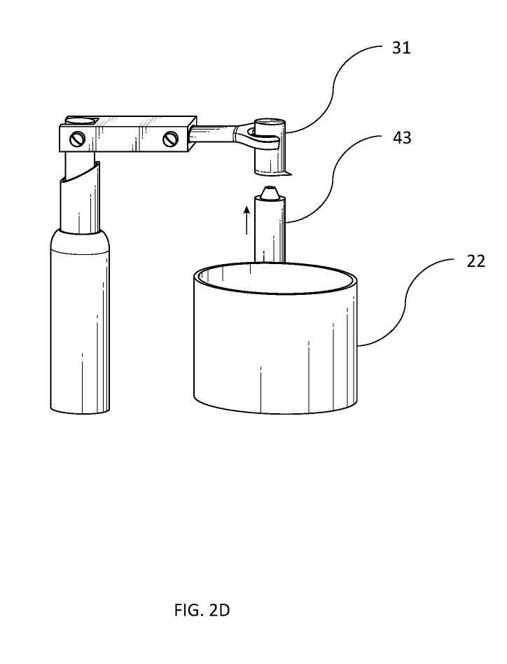

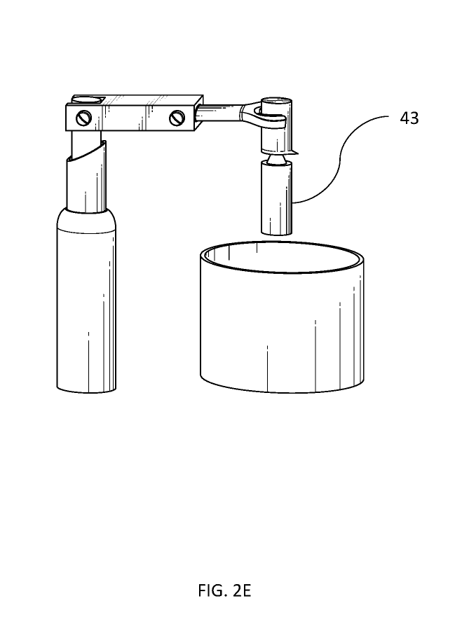

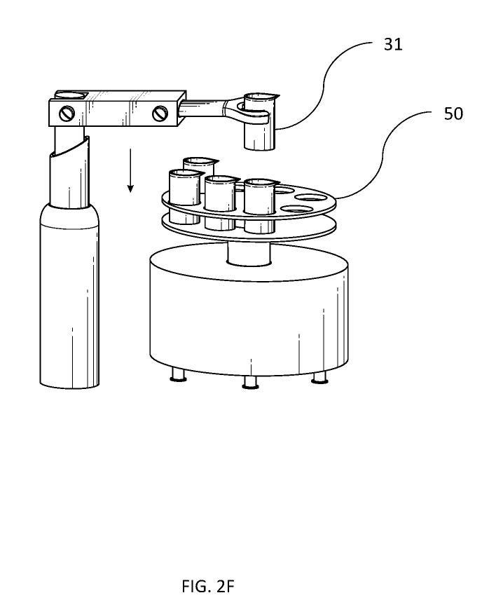

Referring now to FIGS. 2A-2F, one of the robotic arms 20, 23 is shown throughout the process of collecting, cleaning, and loading the fluids in an embodiment of the present invention. FIG. 2A illustrates the robotic arm 20 engaging and lifting a sample cup 31 from the titrator 35. FIG. 2B illustrates the robotic arm 20 rotating about an axis of rotation 23 to orient the sample cup 31 over a drain 22 or other waste reservoir. FIG. 2C illustrates an engaging portion 37 of the robotic arm articulating to dispose the fluid within the sample cup 31 into the drain 22. A spray nozzle 43 is positioned to wash the sample cup 31. The spray nozzle 43 may be in a fixed location, requiring the robotic arm to rotate into the spray nozzles 43 communicable range, or the spray nozzle 43 is in communication with another robotic element (not shown). In FIGS. 2E and 2F and the spray nozzle 43 cleans the sample cup and allows it to drain before returning the sample cup to a titrator 35, storage rack (not shown), or drying carriage 50.

In an embodiment, each member 19 is hingedly connected by connection means 47 to the body portion 18 of the robotic arm. Connection means may include a hinge, locking pin, or other means known in the arts of mechanical robotics.

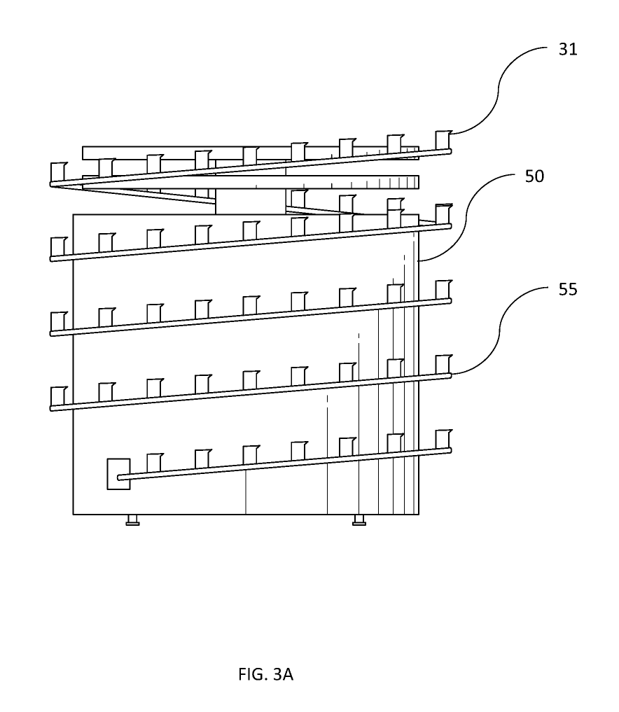

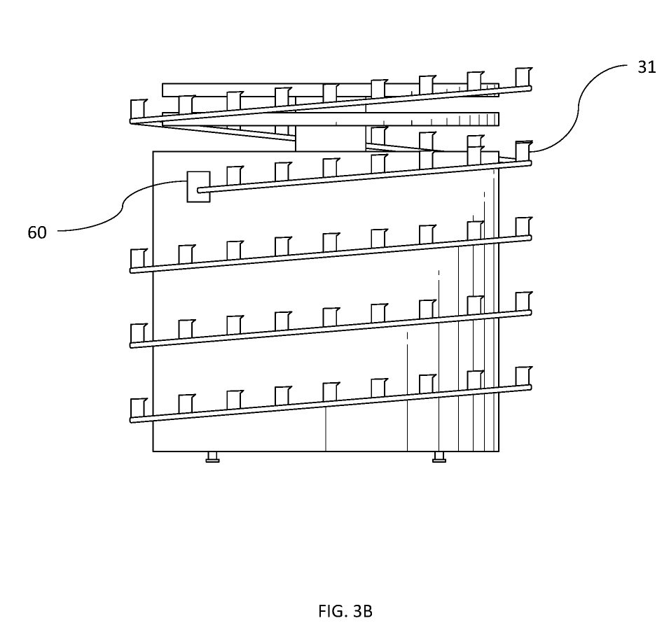

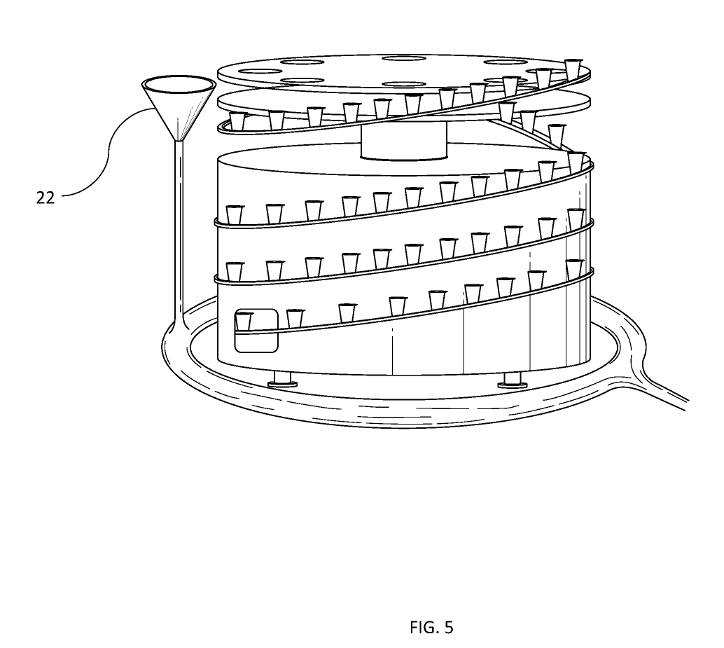

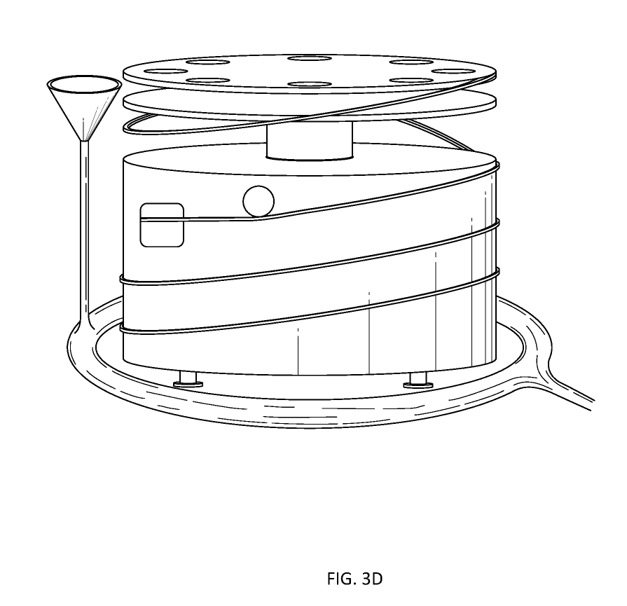

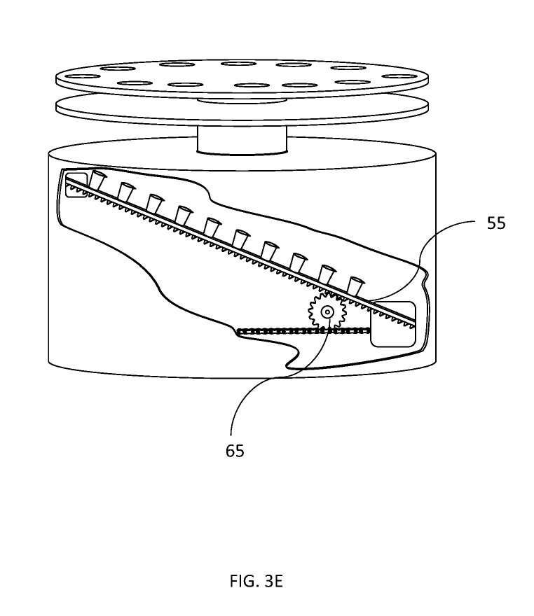

In reference to FIGS. 3A-3E, a drying carriage 50 is shows in an embodiment of the present invention. In embodiment, the drying carriage is in communication with a drain wherein fluids are disposed by the robotic arm 20. Sample cups 31 are loaded onto a moveable track 55 on the drying carriage 50. As each sample cup moves through the drying carriage, dry sample cups are lifted from the carriage and returned to the system for filling, cleaning, titration, and other analytics as determined and programmed by the user. In an embodiment, a drain is positioned substantially near the drying rack such that contents from the sample cups 31 may be disposed therein. Disposing of contents may be accomplished by the rotating robotic arms as described herein.

In an embodiment, and in reference to FIG. 3B, an aperture 60 is positioned through the drying carriage 50. The moveable track 55 extends through the aperture 60 permitting sample cups 31 on the moveable track 55 to move into the interior of the drying carriage. In specific reference to FIG. 3E, a cutaway view of the interior of the drying carriage is shown in an embodiment of the present invention. The moveable track 55 may be mechanically engaged with a sprocket 65 or similar means of mechanical engagement which moves the track.

The present invention includes a system and method of automating a titration system. The solution pump may pump the chemical, from the supply, to be tested by the titrator through a supply line. The supply line thickness should be as thin as possible to avoid wasted solution and should depend on the length of the line to the titrator. A catch test of the pump to properly fill the drip chamber is performed upon installation to avoid over and underuse of solution.

The drip chamber receives the solution. Once adequately filled, the robotic arm is transported to the scale by the robotic arm. Once over the scale, the drip chamber begins the drip process by means of an infusion pump. A flow preventer, by means of the programmable logic computer, shall release only a hundredth of what the necessary aim weight needs. For example, if an aim weight for the titration is 0.50-0.60, once the solution has been measured to 0.49, one more drip of 0.01 may be delivered. The programmable logic controller then stops the drip once it has achieved aim weight.

A programmable logic controller 70 (PLC) is in communication with the infusion pump and flow preventer. In an embodiment, the PLC controls the output of fluids by adjusting each pump 25. The PLC directs pump speed for each pump 25 and rate of flow through the flow preventer to make calculations from the pump speeds and concentration of titrant to determine quantitative aspects of the fluid sample being collected. It is desired to maintain as large a flow rate as possible through the system as possible in order to decrease the time of each titration event. In this manner, a predetermined amount of titrant is added at a rapid rate. Thereafter, the PLC slows the rate of fluid moving through the flow preventer until a first threshold value is reached. At this point, the flow preventer shifts to predetermined reduced increments of fluid until the titration is complete. Volume required to reach the equivalence point may be printed out, stored in local or external memory, transmitted to a network, or recorded by likewise means as known in the art.

It is apparent that the invention may be directed to a system for carrying out a titration having multiple breaks indicating the relationship between pH and volume of titrant added as known in the art.

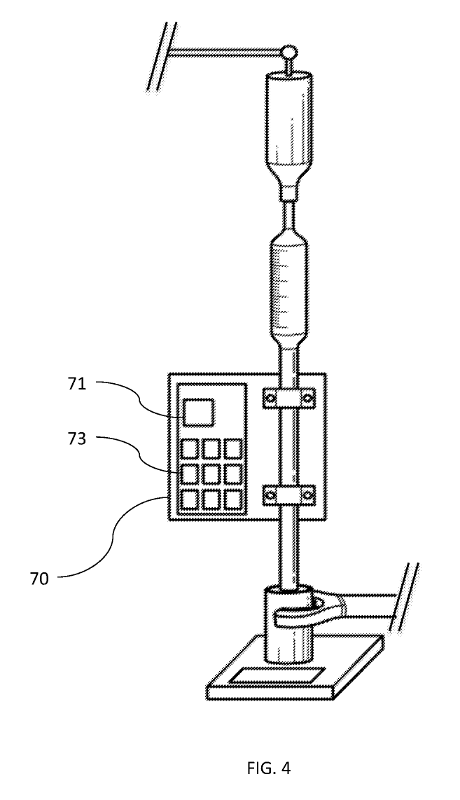

In an embodiment, and in reference to FIG. 4 the PLC 70 comprises a display 71 having and keyboard 73 wherein the user may input a plurality of data, settings, controls, inputs, among other functions known in the art. Each of which is controlled by a plurality of functional keys. The display may also have a series of indicators to alert the user of steps taken during the titration. A memory may be used for temporary or permanent storage of titrator data.

The robotic arm may then transport the drip chamber back to the drain for the clean cycle. Deionized water is pumped through to clean the supply line and the drip chamber over a drain. Alternatively, the drip chamber may remain above the infusion pump, and the deionized water may run through the drop chamber and the infusion pump.

In the sequence, the Programmable Logic Controller (PLC) shall commence as follows:
1. Sample cup is delivered to the scale. Once recognized by the Programmable Logic Controller that the Sample cup is successfully in place, the scale may be zeroed.
2. Solution pump starts and stop once the desired amount has reached the drip chamber.
3. Robotic arm transports the drip chamber to the scale directly over the sample cup. Infusion pump drips the solution from the drip chamber until the aim sample weight is achieved, stop dripping, and move back to the drain position.
4. Clean cycle from the Deionized Water Pump is initiated.
5. The software recognizes the sample is ready, transfer the weight and name the sample by the location the solution was retrieved from the Bias Manager. Robotic arm, takes the cup from the scale and moves it to the titrator. Once recognized in place, the sample starts.
6. Once the sample is complete, the results trigger a reaction, through the PLC, to increase or decrease the pump or auger that feeds the additive which needs tested for. For example Chemical A is water and Chemical B is the additive. An aim percentage of Chemical B is 2.0%. By means of a catch test to the auger or pump, this should be a multiple point of speeds catch test to figure your slope. Once determined an R2 also will be figured to determine the accuracy of the catch test. A Y is also figured which converts to hertz or speeds to know how much to correct to achieve aim through the PLC. With the slope, or by means of a loss in weight system, makes the adjustment from the results of the titration test.
7. After the sample is complete, the robotic arm removes the used sample cup from the Titrator and dumps the contents into the drain. The robotic arm may then move the cup to the spray nozzle.
8. The spray nozzle sprays and cleans the titration cup.
9. The Robotic arm moves the cup to the Autonomous Titrator Cup Dryer Carriage.
10. The Autonomous Titrator Cup Dryer Carriage may include the following. Once the washed cup is placed on the cup peg of the Autonomous Titrator Carriage, it is continuous pegs that move in a spiral from top to the bottom, then back to the top, giving the washed cups time to dry. It moves through a rail system that goes through the entrance, where the carriage is moved by a chain driven inside the dryer. It exits through the bottom of the dryer. A reservoir is underneath the Titrator to catch all dripping water by the cups and is connected to the drain system. The cups exit through the bottom upside down and the whole system gives them time to dry before it gets to the top where robotic arm replenishes the scale with a clean cup. The dried cups are taken by the robotic arm to move to the scale for the next sample.

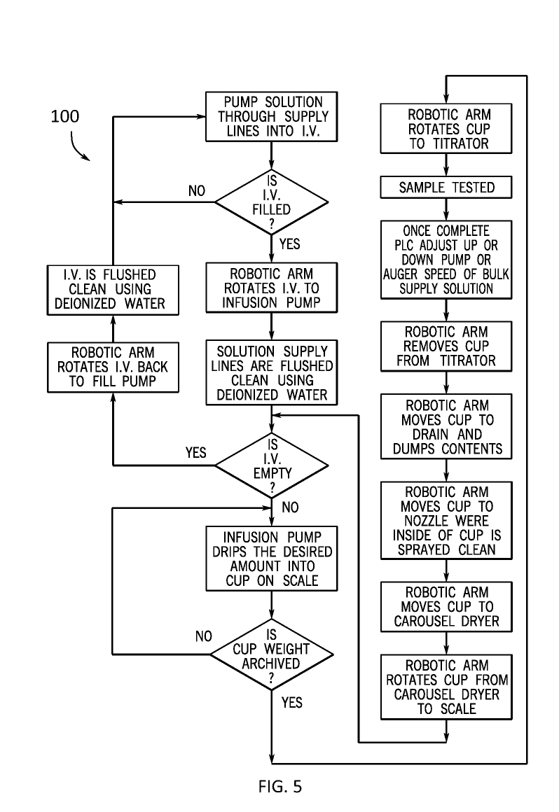

Referring to FIG. 5, the present invention includes a method 100 of titrating a solution. The method may include the following steps: pumping a solution into a drip chamber via a solution pump; dripping the solution from the drip chamber into a cup via an infusion pump, wherein the cup is on a scale; and transporting the cup to a titrator once a threshold weight has been detected. The cup is transported from the scale to the titrator by a robotic arm controlled by a computer. The solution is then titrated by the titrator. In certain embodiments, the drip chamber is transported from the solution pump to the infusion pump by the robotic arm after the solution is pumped into the drip chamber.

The method steps may further include: transporting the drip chamber to a deionized water pump by the robotic arm after the threshold weight has been reached; and pumping a deionized water into the drip chamber via the deionized water pump. In certain embodiments, the deionized water and the solution are pumped through a common supply line. Therefore, the solution is flushed from the common line while the deionized water is pumped into the drip chamber.

The method of the present invention may further includes the steps of: dumping the solution from the cup by the robotic arm after the solution has been titrated; spraying the cup with a cleaning solution via a spraying mechanism; and transporting the cup to a drying rack via the robotic arm. The drying rack may be a carousel dryer. The robotic arm may rotate a cup from the carousel dryer to the scale to start the steps over again.

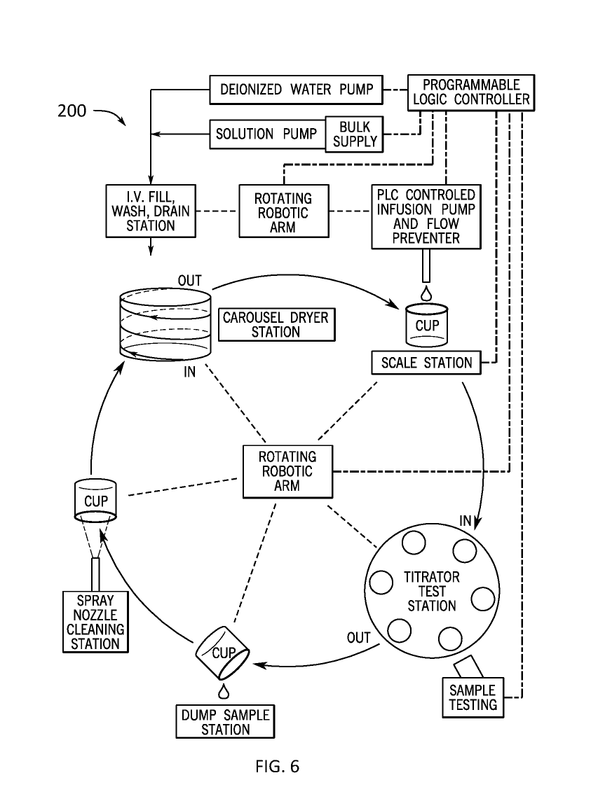

Referring to FIG. 6, the present invention includes a system 200 for titrating a solution. The system includes a robotic arm, a titrator, a solution pump, an infusion pump and a scale. The system further includes a computer having a memory and a programmable logic controller. The computer may be a programmable logic controller. The programmable logic controller of the computer activates the solution pump to pump a solution into a drip chamber, directs the robotic arm to place a cup on the scale, activates the infusion pump to drip the solution from the drip chamber into the cup until a threshold weight has been reached, and directs the robotic arm to transport the cup to the titrator. In certain embodiments, the programmable logic controller directs the robotic arm to transport the drip chamber from the solution pump to the infusion pump after the solution is pumped into the drip chamber.

The system of the present invention may further include a deionized water pump. In such embodiments, the programmable logic controller directs the robotic arm to transport the drip chamber to the deionized water pump after the threshold weight has been reached, and activates the deionized water pump to pump a deionized water into the drip chamber. In certain embodiments, the deionized water and the solution are pumped through a common supply line. Therefore, the solution is flushed from the common line while the deionized water is pumped into the drip chamber.

The system of the present invention may further include a spraying mechanism and a drying rack. The programmable logic controller may further direct the robotic arm to dump the solution from the cup after the solution is titrated, activates the spraying mechanism to spray the cup with a cleaning solution, and directs the robotic arm to transport the cup to the (Autonomous cup drying carriage) drying rack.

As illustrated in FIG. 2, the robotic arm may be a rotating robotic arm. The rotating robotic arm may rotate about a longitudinal axis of the robotic arm. In such embodiments, a plurality of stations may be disposed circumferentially about the robotic arm. For example, a scale station, a titrator test station, a dump sample station, a spray nozzle cleaning station and a carousel dryer station may encircle the rotating robotic arm. Therefore, the robotic arm may rotate about the longitudinal axis to transport the cup from the scale to the titrator, to the drain, to the spray nozzle, to the dryer and then back to the scale.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for titrating a solution comprising;
a. a plurality of robotic arms;
b. a titrator;
c. a solution pump;
d. an infusion pump;
e. a scale; and
f. a computer comprising a memory and a programmable logic controller,
wherein the programmable logic controller performs the following;
activates the solution pump to pump a solution into a drip chamber;
directs at least one of the plurality of robotic arms to place a sample cup on the scale;
activates the infusion pump to drip the solution from the drip chamber into the sample cup until a threshold is reached; and
directs at least one of the plurality of robotic arms to transport the sample cup to the titrator wherein the solution is titrated.

2. The system of claim 1, further comprising a spraying mechanism and a drying rack, wherein the programmable logic controller directs the robotic arm to dump the solution from the cup after the solution is titrated, wherein the programmable logic controller activates the spraying mechanism to spray the cup with a cleaning solution, and wherein the programmable logic controller directs the robotic arm to transport the cup to the drying rack.

3. The system of claim 1, wherein the programmable logic controller directs the robotic arm to transport the drip chamber from the solution pump to the infusion pump after the solution is pumped into the drip chamber.

4. The system of claim 1, further comprising a deionized water pump, wherein the programmable logic controller directs at least one of the plurality of robotic arms to transport the drip chamber to the deionized water pump after the threshold weight has been reached, and wherein the programmable logic controller activates the deionized water pump to pump deionized water into the drip chamber.

5. The system of claim 4, wherein the deionized water and the solution are pumped through a common supply line, wherein the solution is flushed from the common line while the deionized water is pumped into the drip chamber.

6. The system of claim 1, wherein the programmable logic controller directs at least one of the plurality of robotic arms to transport the sample cup to one or more auxiliary analytical devices.

7. A method of titrating a solution comprising the steps of:
a. pumping a solution into a drip chamber via a solution pump;
b. dripping the solution from the drip chamber into a sample cup via an infusion pump wherein the sample cup is positioned on a scale;
c. transporting the cup to a titrator once a threshold has been detected, wherein the sample cup is transported from the scale to the titrator by a robotic arm controlled by a computer, and wherein the solution is titrated by the titrator.

8. The method of claim 7, further comprising the steps of:
a. dumping the solution from the cup by the robotic arm after the solution has been titrated;
b. spraying the cup with a cleaning solution via a spraying mechanism; and
c. transporting the cup to a drying rack via the robotic arm.

9. The method of claim 7, further comprising the step of transporting the drip chamber from the solution pump to the infusion pump by the robotic arm after the solution is pumped into the drip chamber.

10. The method of claim 7 further comprising the steps of:
a. transporting the drip chamber to the deionized water pump by the robotic arm after the threshold weight has been reached, and
b. pumping deionized water into the drip chamber via the deionized water pump.

11. The method of claim 10, wherein the deionized water and the solution are pumped through a common supply line, wherein the solution is flushed from the common line while the deionized water is pumped into the drip chamber.

12. The method of claim 7, wherein the threshold is reached by the programmable logic controller performing the following steps;
a. dripping the solution into the sample cup until a first threshold value is reached;
b. reducing drip increments to a predetermined volume; and
c. continuing to drip the reduced increments until an equivalence point is reached.

13. The method of claim 12, wherein the equivalence point is stored in a memory.

14. The method of claim of claim 7 further comprising the step of transporting the sample cup to one or more auxiliary analytics devices.
